(19) United States
(12) Patent Application Publication
(10) Pub. No.: US 2008/0256494 A1
(43) Pub. Date: Oct. 16, 2008

(54) TOUCHLESS HAND GESTURE DEVICE CONTROLLER

(75) Inventor: ELLIOTT GREENFIELD, ELKINS PARK, PA (US)

Correspondence Address: GREENFIELD MFG, CO., 920 LEVICK ST., PHILADELPHIA, PA, 19111-5498, US

(73) Assignee: GREENFIELD MFG CO INC, PHILADELPHIA, PA (US)

(21) Appl. No.: 11/735,942

(22) Filed: Apr. 16, 2007

(51) Int. Cl. G06F 3/033

(52) U.S. Cl. 715/863

(57) ABSTRACT

A simple user interface for touchless control of electrically operated equipment. Unlike other systems which depend on distance to the sensor or sensor selection this system depends on hand and or finger motions, a hand wave in a certain direction, or a flick of the hand in one area, or holding the hand in one area or pointing with one finger for example. The device is based on optical pattern recognition using a solid state optical matrix sensor with a lens to detect hand motions. This sensor is then connected to a digital image processor, which interprets the patterns of motion and outputs the results as signals to control fixtures, appliances, machinery, or any device controllable through electrical signals.

### FIELD OF INVENTION

This invention relates to the use of a digital video image sensor, which responds to hand gestures and hand motions in front of it to control devices.

### DESCRIPTION OF PREFERRED EMBODIMENT

A user interface utilizing an electronic optical video camera array matrix to sense hand motions hand positions, and hand gestures. This camera array matrix is connected to and sends successive images to the image processor which is programmed to interpret these images and then send signals to control electrically controllable devices.

### BACKGROUND OF INVENTION

This invention is a user interface for touchless control of electrically operated equipment. Other systems, which have been invented for touchless control, depend on reflective light sensors to measure intensity or distance or the selection of optical sensor to control devices. This invention instead uses a video image processor to detect hand and or finger motions, hand gestures, or a hand wave in a certain direction, or a flick of the hand in one area, or holding the hand in one area or pointing with 1 finger as example. The device is based on optical pattern recognition using a solid state optical matrix sensor with a lens to detect hand these motions. By using a video imaging system more complex commands can be realized. The video sensor is connected to a digital image processor, which interprets the patterns of motion and outputs the results as signals to control plumbing fixtures, appliances, machinery, or any device controllable through electrical signals.

### BACKGROUND ART

In public facilities, automatic water delivery fixtures are widely used to reduce the spread of germs and water consumption. These fixtures provide touchless on and off control of a stream of water through sensing means. For example, U.S. Pat. No. 5,025,516 issued to Wilson on Jun. 25, 1991 discloses a faucet with sensing means for automatic operation in the form of an emitter and detector mounted on the spout. Some automatic water delivery fixtures provide a stream of water at a predetermined temperature and flow, such as U.S. Pat. No. 5,458,147 issued to Mauerhofer on Oct. 17, 1995. The Mauerhofer patent only refers to a single scanner beam and not a video array as proposed here.

Other automatic water delivery fixtures provide manual controls for the adjustment of water temperature and flow, such as U.S. Pat. No. 5,309,940 issued to Delabie et al. on May 10, 1994. This patent refers only to a photo cell as the means of detection and control.

U.S. Pat No. 5,868,311 reissued as REF 37,888 to Cretu-Petra on Oct. 22, 2002 refers to using distance from the sensor to control temperature not an image detector.

U.S. Pat No. 6,321,785 issued Nov. 27, 2001 which uses two sensors to control water temperature using timing signals from these two sensors uses no image processing and could not respond to more complex control such as temperature and flow. Moreover it requires many sensors to accomplish even the simplest of commands.

U.S. Pat. No. 5,994,710 issued Nov. 30, 1999 to Knee gives a good description of the optical scanning technology being employed. This patent refers exclusively to an optical computer mouse pointer device and does not involve hand motion or hand gestures.

U.S. Pat. No. 7,138,620 issued Nov. 21, 2006 to Trisnadi uses coherent light and speculation of that light to sense motion to navigate on a surface and not an image outline such as a hand.

U.S. Pat. No. 7,115,856 issued Oct. 3, 2006 to Peng et al refers to reflective sensors to detect hand movements and not the detection of images which could then be processed to detect movements of the hand or fingers.

Beyond the information currently available with in the patent search archives are computer interface systems using 2 or more cameras and a virtual plane as a computer interface device; “Touchlight an imaging screen for gesture based interaction” is such a system ( see ICMI '04 Oct. 13, 2004 State College, Pa. {ACM 1-58113-890-3/04/0010}. This system has the desired effect to interact with graphics display screens. All of the applications referenced in this document are designed to interact with displays. Its object is to create a more versatile touch screen. There is no reference to a touchless interface. This paper has no reference to using camera technology to create touchless control of devices or appliances.

A similar touch surface interface for computer rear projection screens is The Holowall and Holotable developed by Jun Rekimo of Sony Computer Science Laboratory in Tokyo Japan. Again these Papers concentrate on creating a computer user interactive touch screen environment using a surface which they clearly want people to touch. The HoloWall depends on projected images to be placed in front of a viewer on a surface or glass screen. It then uses a similar camera system to see hand motions touching that screen or panel. The idea of this system is to sense the touches to the screen. And use this surface as a large computer interface touch surface and sense the touching of this surface. There is no idea here of creating a touchless environment for its sanitary or aesthetic purposes. The system also relies on projected images and not random motions of hands.

The use of hand gestures for control of computer interactive environments is shown in a paper by Mike Wu, and Ravin Balakrishnan from Department of Computer Science University of Toronto in their paper entitled “Multi-Finger and Whole Hand Gestural Interaction Techniques for Multi-user Tabletop Displays”. Here a touch screen display is used to interpret the hand positions on the screen. Although useful this does not offer a sanitary touchless environment, as does this invention.

Although automatic water delivery fixtures have been successfully installed in public facilities, they have several shortcomings, which deter household or domestic use. Some locations such as hospitals, operating rooms, nursing homes, food processing areas and military bases require a faucet to deliver both hot and warm water for hygienic reasons and cold water for consumption purposes. Many homeowners find the delivery of water from a faucet at a predetermined temperature and flow inadequate for their needs. The requirements are for a more sophisticated control system to allow this.

This interface also allows for the use of the hand signals in any area where a more sterile biological environment would be desired such as in operating theaters or doctors offices.

This invention allows for complex sanitary control of many different devices not just faucets. This invention could also be used in security devices, which would be sensitive to only specific hand signals or movements or in elevators where a circular motion of a finger could point to a floor designator without touching a panel or a button and transmitting germs to one another.

This invention would be suitable for many handicap individuals who may lack certain motor skills enabling them to activate devices by touching controls. With this invention they could activate devices by using movements which they may still have available to them. By using the teach mode, an assistant could program the interface to react to these gestures.

### SUMMARY OF THE INVENTION

The object of the present invention is to provide a user interface, which can interpret control signal commands from the user's hand waves and gestures. A small digital video camera sensor array images video of the user's hand passing in front of it. This invention allows for more complex control of these devices. Faucets with both on and off as well as flow rate and temperature control are possible. Lamp switches having preset modes are selected by holding up a certain number of fingers or pointing in a certain direction. Rotating the hand to increase or decrease flow or loudness or brightness. All this is done sanitarily without touching anything. Custom audio systems could have completely blank front plates with only a display hidden behind a darkened pane and all the controls hidden from view. Gesture of the hand would control all the various functions of the system.

In the medical operating theater, where sterility is important, doctors and surgeons could adjust equipment without worrying whether they were losing the sterile environment they so diligently maintain.

In public facilities of all types higher levels cleanliness could be afforded by this invention by not having to touch any surfaces, which could contain disease bacteria or viruses of any kind.

### DETAILED DESCRIPTION OF THE INVENTION

FIG. 1 shows a digital image processor 2 connected to a video camera 1 that is programmed through an algorithm to respond to various hand gestures and movements within its field of view. The processor then interprets these hand gestures noting their position, speed if any, and direction of movement. It then sends appropriate control command signals to a connected fixture, device or appliance controller 3. In this example the device is a temperature and flow controller for a shower 6. This controller then uses two motorized valves 4 and a temperature sensor 5 to maintain the commanded water temperature and flow rate.

An embodiment of one of the many possible algorithms, and configurations which could be used is as follows:

Surrounding the video camera lens is a ring of pulsed infrared light emitting diodes (LED's). The lens would be equipped with a dark infrared filter restricting most visible light not close or within the infrared spectrum. By doing this much ambient room light and background surfaces not illuminated by the infrared light source would not appear to the image matrix.

The image matrix from the video camera is converted within the processor to a two dimensional array where each pixel would be represented as an intensity value within the array. Two successive images, and thus arrays, would be consecutively captured at high speed, one with the infrared LED's on and one with it off. These two image arrays would then be subtracted from one another. The remaining array values would take objects or images appearing in both scans out of the picture leaving only those objects within the range of the infrared ring light. By limiting the intensity of these LED's, objects too far away could be ignored. This also reduces ambient lighting sources appearing in the image array.

Several scans are compared. Each pixel is compared to a previous one at very high speed. The processor would ignore those pixels not of common value. That means that only those signal values, which repeated for several scans or persisted are evaluated. The most common of several scan values would be used. The calculations would throw out the odd one and average the rest. This would eliminate fast moving objects such as insects, dust or shower spray.

An optional digital filter would then be applied. All changes from pixel to pixel would require a minimum change. If this threshold were not met then the two pixels would be averaged. This would ignore all slow transitions and thus blend in blurred objects and enhance object edges. A Sobel edge detection algorithm or gradient or Laplacian method could also be used. The gradient method detects the edges by looking for the maximum and minimum in the first derivative of the image. The Laplacian method searches for zero crossings in the second derivative of the image to find edges. The Sobel operator performs a 2D spatial gradient measurement on an image. The Sobel edge detector uses a pair of 3'3 convolution masks, one estimating the gradient in the x-direction (columns) and the other estimating the gradient in the y-direction (rows). A convolution mask is usually much smaller than the actual image. As a result, the mask is slid over the image, manipulating a square of pixels at a time.

Next the values within the entire array would be averaged. All the pixel values within the array would be added together and divided by the total number of pixels. This average value would then be used as a threshold. This threshold value would be used two ways. If too high the ring of LED's would have their current reduced. This in turn would reduce the light output and further limit the sensitivity of the video camera if required. If within calculable range this value is used as a black white threshold. Those values above average would be set to on (white=1) while those below would be set to off (black=0) this would create a working binary array image of the hand.

Next the image array could then be cropped. Successive black (0) borders would be removed after which the image size would then be scaled and thus centered to a normalized size for further evaluation.

This binary array is then scanned in spaced parallel lines of various angles. See FIG. 4A, 4B,5A,5B. In the case of a rotary application (The gesture of twisting a control knob by rotating the hand.) the scan lines would emulate concentric circular patterns out of an averaged center of the image. See FIGS. 6A and 6B. The array could also be scanned with radial patterns from an averaged center of the image. This arrangement would show movement as in the making of a fist or from in and out motion.

These scans would then produce signals with various pulse widths and spacing. By comparing these pulse widths and spacing certain patterns appear. Those patterns of fingers as compared to wrists or the side of the hand verses the palm of the hand. The number of fingers can be determined or the angle of the hand could be calculated. These patterns would be compared for shifting. As the hand is moved so the leading edge of the pattern is shifted indicating hand motion. See FIGS. 5B and 6B. The rate of shift in the leading edge spacing would indicate speed of motion. Slower motion would be evaluated as intentional command control while faster movements could accelerate response while even faster speeds would be ignored as approach or retraction from the field of view. During these times, a delay could be incorporated to ignore the entry of the hand into the view field. Thus a hand would need to be in place to start to generate a signal to the system.

The scans could also be checked for finger counts (See FIG. 4A through 6B) as well as spacing for size changes to detect in and out motion.

After detecting a non-regular pattern, the system would be able to store this new pattern. The pattern could then via a traditional operator interface be stored as a new command. This gives the system a teach mode with which a user can now define new commands to the system.

The focusing and aperture of the lens may be designed to ignore objects too far away, which would be blurred and out of focus. Infrared light has a different focusing range in commonly made lenses thus the lens in this case is appropriately designed for the infrared spectrum. In this application a short depth of focus would be desirable so as to limit the focus only to the desired working distance.

An example of the application of this invention would be on a water faucet as in Fig.2. Here a user would hold up 2 fingers to indicate the control of temperature. An algorithm similar to the one described in U.S. Pat. No. 4,628,533 by Hongo could be used to recognize the two fingers. This patent refers to character recognition, a widely used technique. This same technique in a slightly modified version could be used. The image processor would through pattern shifting observe the change in motion of the fingers. From right to left. This would increase the temperature value on a nearby display and send a change temperature signal to the temperature valve controller as shown in FIG. 1.

Holding up one finger would tell the system to adjust the flow rate of the water. Moving to right could increase flow while moving to the left would decrease flow. A Wave up would start the flow of water. A wave down of the hand could stop the flow of water.

Similarly another application would be to operate several lamps in a home lighting system. See FIG. 3. Here a user would hold up three fingers to indicate lamp number three and then raise or lower three fingers to brighten or dim lamp three. Sweeping down with ones hand would extinguish all the lamps in the system. Sweeping ones hand up would turn all the lamps on.

The processing speed available in microprocessors or digital signal processors will only increase in the future enabling redundancy of these algorithms thus increasing the system's reliability and response rate.

The stored program would then output control signals or a train of control signals to the controlled device. It could even directly control a relay or motor to operate a device directly.

The touchless control of instruments and appliances and other devices with more than just on and off signals will revolutionize how people interact with the devices around them. The use of this system will enable people to operate the devices they use everyday quietly and most important sanitarily.

While my above descriptions contain many specificities, these should not be construed as limitations of the scope of the invention, but rather as exemplification of one preferred embodiment thereof. Accordingly, the scope of the invention should be determined not by the embodiments illustrated, but by the appended claims and their legal equivalents.

### BRIEF DESCRIPTION OF THE DRAWINGS

FIG. 1 shows the control out line of the invention. The invention relates only to the image detector 1 and the image processor 2. The image detector 1 is a video image matrix which has a lens and captures the image as a video camera would and then sends an image to the image processor 2

FIG. 2 shows a picture of a typical sink application. The sensor 1 may be mounted on the faucet or mounted separately or on the display. An optional display 2 is added for user information.

FIG. 3 shows a typical wall switch application. Here the camera and processor are used to control on-off and dimming of one or more controlled circuits.

FIG. 4A shows a scanned image of a hand as the image processor would scan the image as seen by the digital image video camera with parallel lines. This example shows only one of many possible ways to scan the image. The image processor would scan the same image matrix multiple times in different ways and at different angles while looking for pattern matches.

FIG. 4B shows how the data would appear to the image processor on one possible method and at one possible angle scan. Hand motion moves the leading edge.

FIG. 5A shows a different hand position.

FIG. 5B shows how the data would appear differently to the image processor. Here multiple fingers would indicate a different command.

FIG. 6A shows a scanned image of a hand as the image processor would scan the image as seen by the digital image video camera with concentric lines.

FIG. 6B shows how the data would appear to the image processor. Hand rotation moves the leading edge.

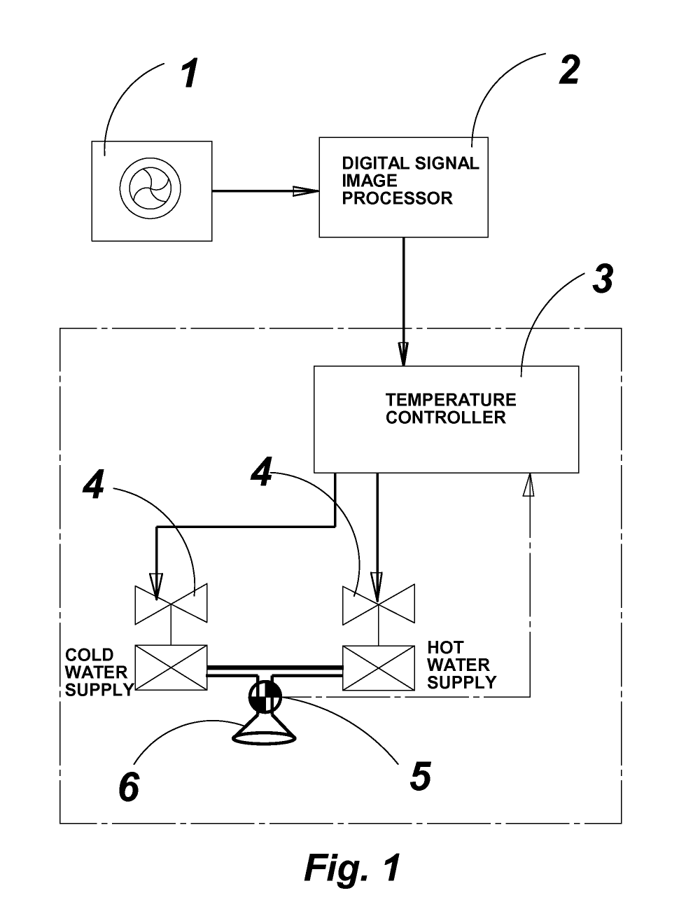

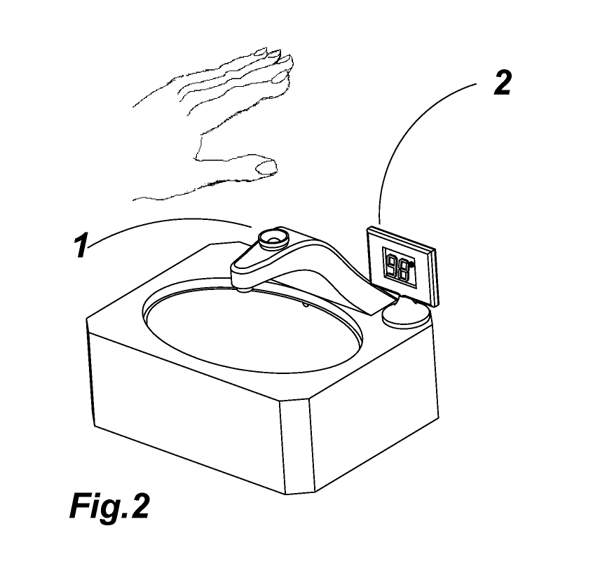

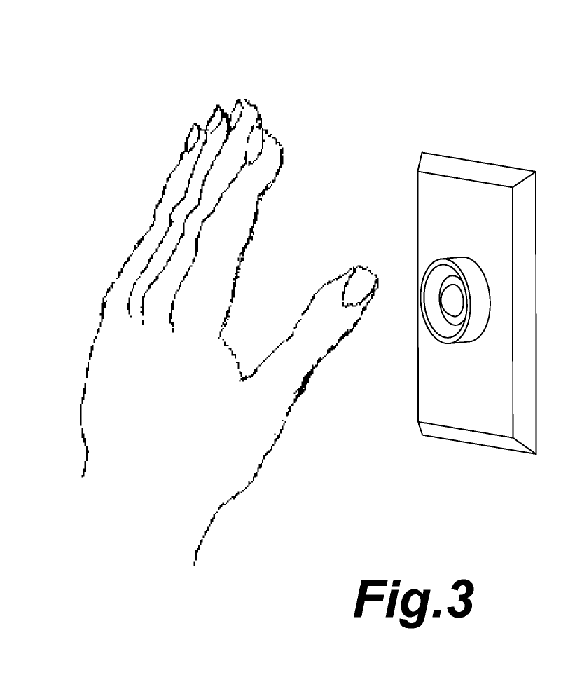

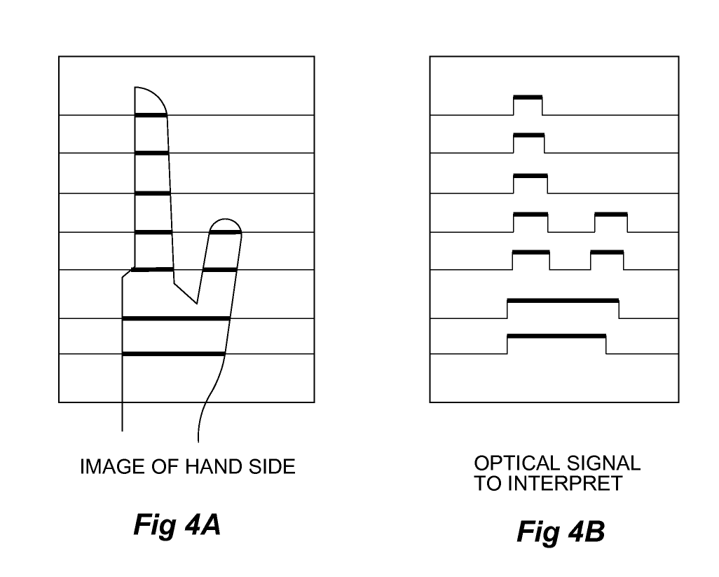

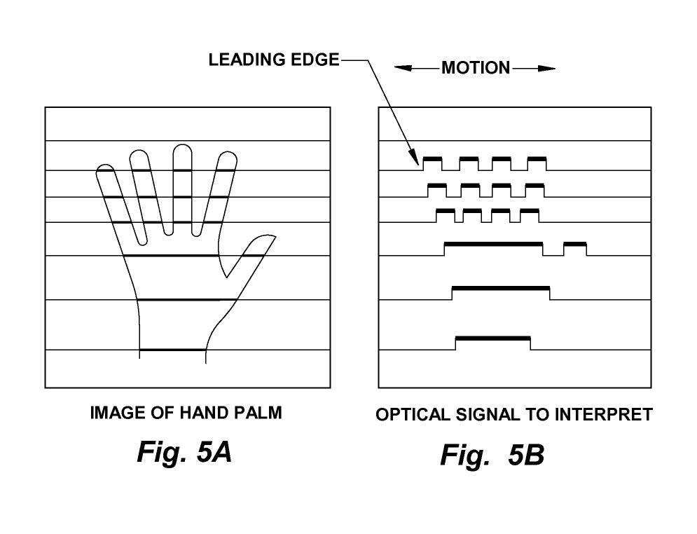

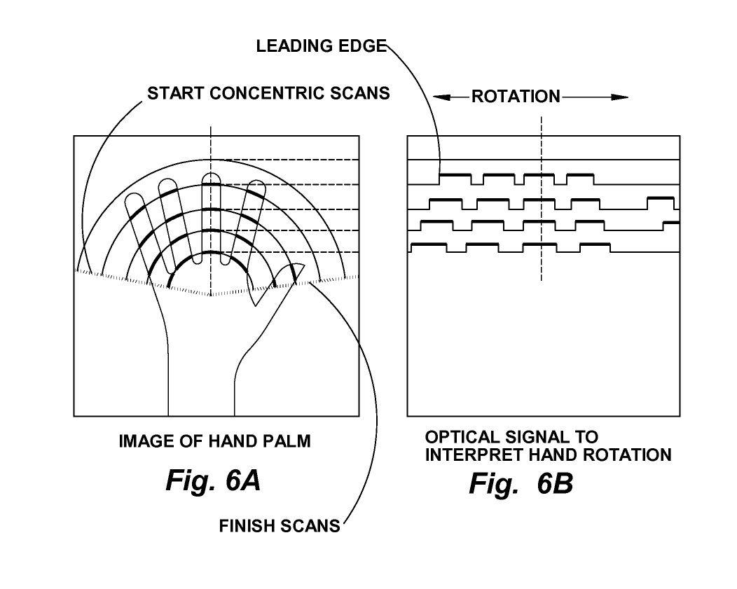

What is claimed is:

1. A touchless operator interface which interprets hand gestures and the movements of these gestures to control electrically controllable devices including plumbing fixtures, electrical instruments, operating room equipment, medical devices, lighting controls, radios, sound equipment, equipment for the disabled, elevators, and clean room processing equipment comprising:
(a) a digital optical video camera sensor means connected to a digital image processor means and
(b) a digital image processor means to interpret hand motions, hand configurations, and hand positions from scans of the digital image at various sequential times from which the digital image processor generates signals for controlling connected devices and
(c) an output connection means to send the control signals to the controlled devices.

2. An operator interface as in claim 1 which has a user interpretable display.

3. An operator interface as in claim 1 which has a teach option to learn user specific hand gestures and the movement of these gestures.

4. An operator interface as in claim 1, that can sense ambient light, levels.

5. An operator interface as in claim 1 that contains its own lighting source of pulsed or continuous light.

6. An operator interface as in claim 1 that can operate in the infrared region of the spectrum.
